(19) United States
(12) Patent Application Publication
(10) Pub. No.: US 2010/0282871 A1
(43) Pub. Date: Nov. 11, 2010

(54) FUEL INJECTION VALVE DEVICE

(76) Inventors: Hiroshi Yoshizumi, Kanagawa (JP); Hajime Suzuki, Kanagawa (JP); Masataka Ota, Kanagawa (JP)

Correspondence Address: WENDEROTH, LIND & PONACK, L.L.P., 1030 15th Street, N.W.,, Suite 400 East, Washington, DC, 20005-1503, US

(21) Appl. No.: 12/811,412

(22) PCT Filed: Jan. 28, 2009
(86) PCT No.: PCT/JP2009/051821

§ 371 Date: Jul. 1, 2010

(30) Foreign Application Priority Data
Feb. 13, 2008 (JP) 2008-031399

(51) Int. Cl. F02M 61/10; F02M 61/18

(52) U.S. Cl. 239/533.3

(57) ABSTRACT

A fuel injection valve can be provided, with which temperature at needle valve seating position can be decreased and carburization of fuel and deposition of the carbide near the needle valve seating position can be prevented resulting in stable normal fuel injection control, and which is applicable to small and middle and also to large engines, particularly gas engines. The fuel injection valve is composed such that distance (A) from a seating face of the nozzle in the nozzle supporting body to a seating position of the needle valve in the nozzle is determined to be smaller than distance (B) from the nozzle seating face in the nozzle supporting body to the lower end of clearance between a nozzle insertion hole of the nozzle supporting body and a fitting part of the nozzle inserted into the nozzle insertion hole, thereby suppressing heat flow to the needle valve seating position.

### TECHNICAL FIELD

The present invention relates to a fuel injection valve device used for pilot injection valve device of a gas engine.

The nozzle device comprises a nozzle having injection holes at its tip, a needle valve fit in the nozzle slidably to control fuel injection through the injection holes, and a supporting body for supporting the nozzle and providing cooling liquid space for accommodating cooling liquid to cool the substantial part of the nozzle, and composed so that temperature at the needle valve seating position is decreased by suppressing heat flow to the needle valve seating position of the nozzle.

### BACKGROUND ART

An injection nozzle of a fuel injection valve device of an internal combustion engine is located near the combustion chamber of the engine and partly exposed to high temperature combustion gas in the combustion chamber. Therefore, temperature at the needle valve seating position in the nozzle rises, fuel near the seating position is carburized, and the carbide tends to deposit on the needle valve seat. Inability of normal fuel injection control which induces abnormal combustion and decrease in engine performance tends to occur when the carbide deposition peels off partially resulting in insufficient seating of the needle valve.

Means of cooling the nozzle by cooling liquid are widely adopted in order to prevent occurrence of carburization of fuel at the needle valve seating position. One of those means is disclosed in Japanese Laid-Open Patent Application No. 2007-205295 (latent literature 1).

According to the latent literature 1, the fuel injection valve device of gas engine comprises a cooling water passage to allow cylinder head cooling water to pass through, a valve holder cooling water passage in the forefront part of the valve holder, an end of the passage being connected to the engine cooling water passage in the upstream side from the fuel injection valve, a connection passage connecting the other end of the valve holder cooling passage to the lower pressure part of a cooling water circulating passage for allowing cooling water of a pressure lower than the pressure of the engine cooling water in the upstream side from the fuel injection valve in the, and a heat shield cap covering the nozzle, the heat shield cap having holes to allow the fuel injected from the injection holes of the nozzle to pass through to be injected into the combustion chamber.

In a fuel injection valve device for a relatively small and medium engine, it is necessary to prevent excessive temperature rise at the needle valve seating position without providing cooling water passages around the nozzle.

In the fuel injection valve device of the patent literature 1, however, a plurality of cooling passages are provided in the nozzle holder surrounding the nozzle, so construction of the valve device becomes complicated and increased in outer diameter, which makes it difficult to apply it to a small or middle size engines.

### DISCLOSURE OF THE INVENTION

The present invention was made in light of problems in prior art, and the object of the invention is to provide a fuel injection valve device, with which temperature at needle valve seating position can be decreased and carburization of fuel and deposition of the carbide near the needle valve seating position can be prevented resulting in stable normal fuel injection control, and which is applicable to small and middle and also to large engines, particularly gas engines.

To attain the object, the invention proposes a fuel injection valve device comprising a nozzle having injection holes at its tip, a needle valve fit in the nozzle slidably to control fuel injection timing and amount, and a nozzle supporting body for supporting the nozzle and providing cooling liquid space for accommodating cooling liquid to cool the substantial part of the nozzle, wherein distance (A) from a seating face of the nozzle in the nozzle supporting body to a seating position of the needle valve in the nozzle is determined to be smaller than distance (B) from the seating face of the nozzle in the nozzle supporting body to a lower end of clearance between a nozzle insertion hole of the nozzle supporting body and a fitting part of the nozzle inserted into the nozzle insertion hole, thereby suppressing heat flow to the seating position of the needle valve.

The invention also proposes a fuel injection valve device comprising a nozzle having injection holes at its tip, a needle valve fit in the nozzle slidably to control fuel injection timing and amount, and a nozzle supporting body for supporting the nozzle and providing cooling liquid space for accommodating cooling liquid to cool the substantial part of the nozzle, wherein a flange part is formed in a lower end part of a nozzle insertion hole of the nozzle supporting body such that an opening of diameter smaller than the diameter of the nozzle insertion hole is formed and a part of the lower end face of the nozzle is covered by the flange part.

It is preferable that a seating position of the needle valve in the nozzle is located above a center point of the opening formed by the flange part.

The invention further proposes a fuel injection valve device comprising a nozzle having injection holes at its tip, a needle valve fit in the nozzle slidably to control fuel injection timing and amount, and a nozzle supporting body for supporting the nozzle and providing cooling liquid space for accommodating cooling liquid to cool the substantial part of the nozzle, wherein a nozzle attachment socket is fitted in a nozzle attachment socket insertion hole in the nozzle supporting body, the nozzle attachment socket having a cylindrical part fit into the nozzle attachment insertion hole of the nozzle supporting body, an upper horizontal flange part extending outwardly from the upper part of the cylindrical part to be seated on a seating face of the nozzle attachment socket in the nozzle supporting body, and a lower flange part extending inwardly from the lower part of the cylindrical part to cover a part of the lower end face of the nozzle, a fitting part of the nozzle being inserted into the hollow of the cylindrical part of the nozzle attachment socket with a small clearance.

It is preferable that distance (A) from the nozzle attachment socket seating face in the nozzle supporting body to a seating position of the needle valve in the nozzle is determined to be smaller than distance (B) from the seating face of the nozzle attachment socket in the nozzle supporting body to the lower end of clearance between the nozzle attachment socket insertion hole of the nozzle supporting body and the fitting part of the nozzle inserted into the hollow of the cylindrical part of the nozzle attachment socket.

Heat generated by combustion in the combustion chamber flows from the lower end face of the nozzle and from the outer periphery of the nose part of the nozzle to the needle valve seating position in the nozzle.

However, according to the invention, the distance (A) from a seating face of the nozzle in the nozzle supporting body to a seating position of the needle valve in the nozzle is determined to be smaller than distance (B) from the nozzle seating face in the nozzle supporting body to the lower end of clearance between a nozzle insertion hole of the nozzle supporting body and a fitting part of the nozzle inserted into the nozzle insertion hole, so that the needle valve seating position is located at a position upper than the position of the lower end of the clearance, i.e. the lower end of the fitting part of the nozzle, so distance from the lower end face of the nozzle to the needle valve seating position increases, temperature at the seating position decreases, which decreases temperature of fuel oil near the needle valve seating position.

As a result, formation and deposition of carbide of fuel oil in the vicinity of the needle valve seating position 3 do not occur and occurrence of inability of normal control of fuel injection due to occurrence of carbide deposition and exfoliation thereof can be prevented.

This is realized by only changing the set of the nozzle and needle valve without changing other parts of the fuel injection valve device. This construction is applicable as a matter of course to fuel injection valve devices for relatively small and middle engines and also to fuel injection valve devices for large engines.

According to the invention, a flange part is formed in the lower end part of the nozzle insertion hole of the nozzle supporting body such that an opening of diameter smaller than the diameter of the nozzle insertion hole is formed and a part of the lower end face of the nozzle is covered by the flange part, so heat flow from the end face of the nozzle is decreased, resulting in decreased temperature at the needle valve seating position and its vicinity.

Further, by composing such that the needle valve seating position is located above the center point of the opening of diameter of smaller than the diameter of the nozzle insertion hole, temperature at the needle valve seating position can be further decreased by synergetic effect of the heat shielding effect of the flange part and the increase of the distance from the lower end face of the nozzle to the needle valve seating position.

Furthermore, by composing such that the nozzle attachment socket is provided, of which the cylindrical part surrounds the fitting part of the nozzle and the lower flange part covers apart of the nozzle end face, heat flow into the fitting part of the nozzle from the outer periphery thereof is obstructed by the cylindrical part of the nozzle attachment socket, and heat flow from the nozzle end face is obstructed by the lower flange part of the nozzle attachment socket covering apart of the nozzle end face.

Therefore, heat flow to the needle valve seating position in the nozzle from the outer periphery of the fitting part of the nozzle and from the nozzle end face is greatly suppressed, resulting in decreased temperature at the needle valve seating position in the nozzle and its vicinity.

By composing such that the distance (A) from the nozzle attachment socket seating face in the nozzle supporting body to the needle valve seating position in the nozzle is determined to be smaller than the distance (B) from the nozzle attachment socket seating face in the nozzle supporting body to the lower end of the clearance between the nozzle attachment insertion hole of the nozzle supporting body and the fitting part of the nozzle inserted into the hollow of the cylindrical part of the nozzle attachment socket, temperature at the needle valve seating position in the nozzle can be further decreased by synergetic effect of the heat shielding effect of the nozzle attachment socket and the increase of the distance from the lower end face of the nozzle to the needle valve seating position in the nozzle.

### BRIEF DESCRIPTION OF THE DRAWINGS

FIG. 1 (A) is a cross-sectional view of the substantial part of the pilot fuel injection valve device of a gas engine of the first embodiment according to the present invention, and FIG. 1 (B) is an enlarged sectional view of a part indicated by an arrow Z in FIG. 1 (A).

FIG. 2 is a cross-sectional view of the substantial part of the pilot fuel injection valve device of a gas engine of the second embodiment according to the present invention.

FIG. 3 is a cross-sectional view of the substantial part of the pilot fuel injection valve device of a gas engine of the third embodiment according to the present invention.

### BEST MODE FOR IMPLEMENTING THE INVENTION

The present invention will be detailed hereunder based on several embodiments with reference to accompanying drawings. It is intended, however, that unless particularly specified, dimensions, materials, relative positions and so forth of the constituent parts in the embodiments shall be interpreted as illustrative only not as limitative of the scope of the present invention.

### THE FIRST EMBODIMENT

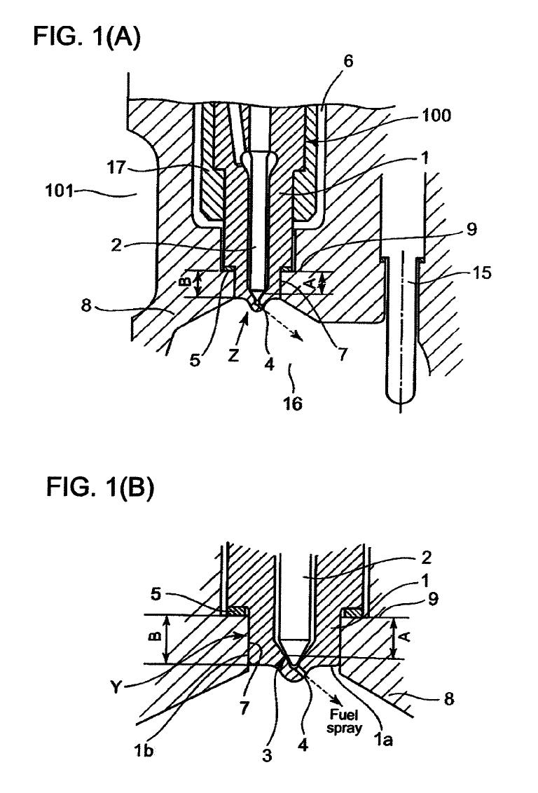

FIG. 1 (A) is a cross-sectional view of the substantial part of the pilot fuel injection valve device of a gas engine of the first embodiment according to the present invention, and FIG. 1 (B) is an enlarged sectional view of a part indicated by an arrow Z in FIG. 1 (A).

Referring to FIG. 1 (A), a pre-combustion chamber 16 is formed in a nozzle supporting body 8. A fuel injection valve device 100 is disposed in the central part of the nozzle supporting body 8, and a glow plug 15 is disposed in range of travel of fuel spray injected from the fuel injector 100.

The fuel injection valve device 100 includes a nozzle 1 having one or more injection holes 4 at the tip thereof and a needle valve 2 fitted slidably in the central hollow thereof, a nozzle support ring 17 for supporting the nozzle 1 in an injection valve body not shown in the drawing, and a gasket 5 made of copper alloy or the like. The injection valve body is attached to the nozzle supporting body 8 in an injection valve body accommodating hollow thereof such that a water room 6 is formed between the outer periphery of the support ring 17 and the inner periphery of the nozzle supporting body 8, and that the shoulder of nose part of the nozzle 1 presses the gasket 5 against a nozzle seating face 9 for supporting the nozzle 1 in the nozzle supporting body 8. As shown in FIG. 1 (B), a fitting part 1b of the nose part of the nozzle 1 is fit into a nozzle insertion hole 7 of the nozzle supporting body 8 with a slight clearance Y. Essential parts of the nozzle 1 is cooled by cooling water in the water room 6.

The nozzle supporting body 8 is surrounded by a cooling water room 101.

In the invention, relation between distance A from the seating face 9 of the nozzle 1 in the nozzle supporting body 8 to the seating position 3 of the needle valve 2 onto the lower end of the central hollow of the nozzle 1 and distance B from the nozzle seating face 9 in the nozzle supporting body 8 to the lower end of the fitting part 1b of the nose part of the nozzle 1 (i.e. the lower end of the clearance Y) is determined such that the distance A is smaller than the distance B so that the needle valve seating position 3 is located at a position upper than the lower end of the periphery of the nose part of the nozzle 1.

Heat flows from a lower end face 1a of the nozzle 1 and from the outer periphery of the nose part of the nozzle 1 facing the clearance Y to the needle valve seating position 3.

However, according to the aforementioned construction, the distance A from the nozzle seating face 9 to the needle valve seating position 3 is determined to be smaller than the distance B from the nozzle seating face 9 to the lower end of the clearance Y, i.e. the lower end of the periphery of the nose part of the nozzle 1, so that the needle valve seating position 3 is located at a position upper than the position of the lower end of the clearance Y, so distance from the lower end face 1a of the nozzle 1 to the needle valve seating position 3 increases, temperature at the seating position decreases, which decreases temperature of fuel oil near the needle valve seating position 3. As a result, formation and deposition of carbide of fuel oil in the vicinity of the needle valve seating position 3 do not occur and occurrence of inability of normal control of fuel injection due to occurrence of carbide deposition and exfoliation thereof can be prevented.

This is realized by only changing the set of the nozzle 1 and the needle valve 2 without changing other parts of the fuel injection valve device 100. This construction is applicable as a matter of course to fuel injection valve devices of relatively small and middle engines and also to fuel injection valve devices for large engines.

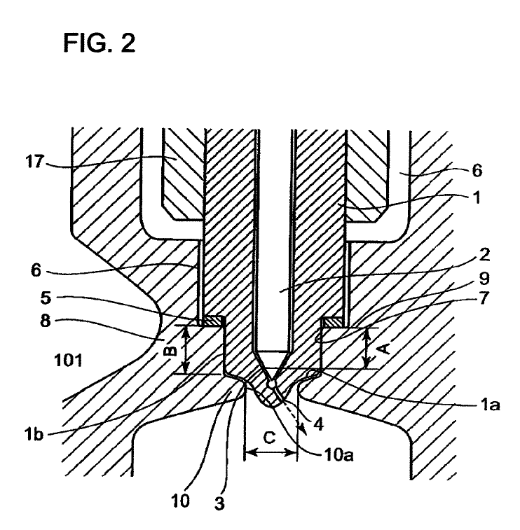

FIG. 2 is a cross-sectional view of the substantial part of the pilot fuel injection valve device of a gas engine of the second embodiment according to the present invention.

In FIG. 2 showing the second embodiment, a flange part 10 is formed in the lower end part of the nozzle insertion hole 7 of the nozzle supporting body 8 such that an opening of diameter of C which is smaller than the diameter of the nozzle insertion hole 7 is formed and the peripheral part of the lower end face 1a of the nozzle 1 is covered by the flange part 10.

In the second embodiment, also the distance A from the nozzle seating face 9 to the needle valve seating position 3 is determined to be smaller than the distance B from the nozzle seating face 9 to the lower end of the clearance Y, i.e. the lower end of the periphery of the nose part of the nozzle 1, so that the needle valve seating position 3 is located at a position upper than the position of the lower end of the clearance Y, as is in the first embodiment.

Construction other than the formation of the flange part 10 is the same as that of the first embodiment, and the same constituent parts are indicated by the same reference numerals.

According to the second embodiment, the peripheral part of the lower end face 1a of the nozzle 1 is covered by the flange part 10 of the nozzle supporting body 8, so heat flow from the end face 1a of the nozzle 1 is decreased, resulting in decreased temperature at the needle valve seating position 3 and its vicinity.

By composing such that the needle valve seating position 3 is located above the center point of the opening of diameter of C, temperature at the needle valve seating position 3 can be further decreased by synergetic effect of the heat shielding effect of the flange part 10 and the increase of the distance from the lower end face 1a of the nozzle 1 to the needle valve seating position 3.

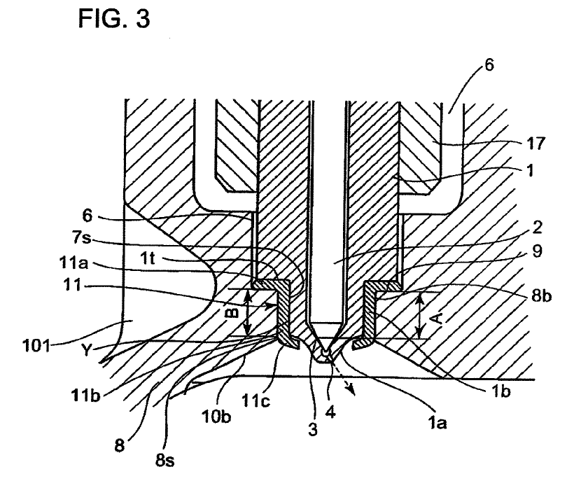

FIG. 3 is a cross-sectional view of the substantial part of the pilot fuel injection valve device of a gas engine of the third embodiment according to the present invention.

In FIG. 3 showing the third embodiment, a nozzle attachment socket 11 having a lower flange part 11c (a nozzle end face covering flange part) is press-fit into a nozzle attachment socket insertion hole 8s of the nozzle supporting body 8. The nozzle attachment socket 11 has an upper horizontal flange part 11a extending horizontally from a cylindrical part 11b to be press-fit into the nozzle attachment socket insertion hole 8s and the lower flange part 11c to cover the peripheral part of the nozzle end face 1a. The fitting part 1b of the nose part of the nozzle 1 is fit into a nozzle insertion hole 7s of the nozzle attachment socket 11 with a slight clearance Y. The upper horizontal flange part 11a of the nozzle attachment socket 11 serves as a gasket between the nozzle seating face 9 in the nozzle supporting body 8 and a shoulder 1t of the nose part of the nozzle 1, and the lower flange part 11c of the nozzle attachment socket 11 covers the peripheral part of the nozzle end face 1a.

According to the third embodiment, the nozzle attachment socket 11 is provided, of which the cylindrical part 11b surrounds the nose part of the nozzle 1 and the lower flange part 11c covers the peripheral part of the nozzle end face 1a, so heat flow into the nose part of the nozzle 1 from the outer periphery of the nose part is obstructed by the cylindrical part 11b and heat flow from the nozzle end face 1b is obstructed by the lower flange part 11c covering the peripheral part of the nozzle end face 1b.

Therefore, the heat flow to the needle valve seating position 3 from the outer periphery of the nose part of the nozzle 1 and from the nozzle end face 1b is greatly suppressed, resulting in decreased temperature at the needle valve seating position 3 and its vicinity.

By composing such that distance A from the nozzle attachment socket seating face 9 to the needle valve seating position 3 is determined to be smaller than distance B from the nozzle attachment socket seating face 9 to the lower end of the clearance Y, i.e. the lower end of the periphery of the nose part of the nozzle 1, temperature at the needle valve seating position 3 can be further decreased by synergetic effect of the heat shielding effect of the nozzle attachment socket 11 and the increase of the distance from the lower end face 1a of the nozzle 1 to the needle valve seating position 3.

As has been described heretofore, the present invention was explained concerning a pilot fuel injection valve device of gas engine, however, the invention is applicable as a matter of course to fuel injection valve devices for relatively small and middle engines and also to fuel injection valve devices for large engines. The invention is applicable also to fuel injection valve devices of diesel engines.

### INDUSTRIAL APPLICABILITY

A fuel injection valve device can be provided, with which temperature at needle valve seating position in the nozzle can be decreased and carburization of fuel and deposition of the carbide near the needle valve seating position can be prevented resulting in stable normal fuel injection control, and which is applicable to relatively small and middle engines and also to large engines.

1. A fuel injection valve device comprising a nozzle having injection holes at its tip, a needle valve fit in the nozzle slidably to control fuel injection timing and amount, and a nozzle supporting body for supporting the nozzle and providing cooling liquid space for accommodating cooling liquid to cool the substantial part of the nozzle, wherein distance (A) from a seating face of the nozzle in the nozzle supporting body to a seating position of the needle valve in the nozzle is determined to be smaller than distance (B) from the seating face of the nozzle in the nozzle supporting body to a lower end of clearance between a nozzle insertion hole of the nozzle supporting body and a fitting part of the nozzle inserted into the nozzle insertion hole, thereby suppressing heat flow to the seating position of the needle valve.

2. A fuel injection valve device comprising a nozzle having injection holes at its tip, a needle valve fit in the nozzle slidably to control fuel injection timing and amount, and a nozzle supporting body for supporting the nozzle and providing cooling liquid space for accommodating cooling liquid to cool the substantial part of the nozzle, wherein a flange part is formed in a lower end part of a nozzle insertion hole of the nozzle supporting body such that an opening of diameter smaller than the diameter of the nozzle insertion hole is formed and a part of the lower end face of the nozzle is covered by the flange part.

3. A fuel injection valve device according to claim 2, wherein a seating position of the needle valve in the nozzle is located above a center point of the opening formed by the flange part.

4. A fuel injection valve device comprising a nozzle having injection holes at its tip, a needle valve fit in the nozzle slidably to control fuel injection timing and amount, and a nozzle supporting body for supporting the nozzle and providing cooling liquid space for accommodating cooling liquid to cool the substantial part of the nozzle, wherein a nozzle attachment socket is fitted in a nozzle attachment socket insertion hole in the nozzle supporting body, the nozzle attachment socket having a cylindrical part fit into the nozzle attachment insertion hole of the nozzle supporting body, an upper horizontal flange part extending outwardly from the upper part of the cylindrical part to be seated on a seating face of the nozzle attachment socket in the nozzle supporting body, and a lower flange part extending inwardly from the lower part of the cylindrical part to cover a part of the lower end face of the nozzle, a fitting part of the nozzle being inserted into the hollow of the cylindrical part of the nozzle attachment socket with a small clearance.

5. A fuel injection valve device according to claim 4, wherein distance (A) from the nozzle attachment socket seating face in the nozzle supporting body to a seating position of the needle valve in the nozzle is determined to be smaller than distance (B) from the seating face of the nozzle attachment socket in the nozzle supporting body to the lower end of clearance between the nozzle attachment socket insertion hole of the nozzle supporting body and the fitting part of the nozzle inserted into the hollow of the cylindrical part of the nozzle attachment socket.
